(19) United States
(12) Patent Application Publication
(10) Pub. No.: US 2006/0091180 A1
(43) Pub. Date: May 4, 2006

(54) Electric stapler

(76) Inventor: Atsushi Kurabayashi, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 10/519,103

(22) PCT Filed: Jun. 24, 2003
(86) PCT No.: PCT/JP03/08002

§ 371 Date: Dec. 27, 2004

(30) Foreign Application Priority Data
Jun. 28, 2002 (JP) 2002-188883

(51) Int. Cl. B25C 5/02

(52) U.S. Cl. 227/131; 227/155

(57) ABSTRACT

A clincher 17 of an electric stapler is provided with a press blade 19 for moving up and down to and from a driver. Recess grooves 21 are formed at two contiguous portions of a stapler injecting port of a driver unit 12 and a front end of the press blade is received by the recess grooves. After pinching sheet by the driver unit and the clincher to bind by a staple, the press blade presses the sheet to the recess groove to press a fold line. An excellent finish is achieved at a binding processing apparatus constituted by the electric stapler and a sheet folding mechanism.

### TECHNICAL FIELD

The present invention relates to an electric stapler, particularly relates to an electric stapler mounted to a binding processing apparatus for carrying out sheets binding processing and sheets folding processing.

### BACKGROUND ART

There is known a binding processing apparatus for striking a staple on a center line in a left and right direction of stacked sheets that is a plurality of sheets of stacked paper and folding the sheets into two by a sheet folding mechanism using a pinch roller. Further, there is also known a complex type copier including a binding processing apparatus of this kind.

FIG. 5 shows an example of a conventional binding processing apparatus art including an electric stapler 1, a sheet folding mechanism 2 and a stack tray 3. The stack tray 3 for receiving sheet discharged from a copier (not illustrated) is inclined to align a sheet end automatically by a self weight of the sheet, and a lower end portion thereof is arranged with a sheet aligning stopper 4 of a lifting type. A middle portion of the stack tray 3 in an up and down direction is arranged with a plurality of the electric staplers 1 to align horizontally in parallel with each other, and a clincher unit 5 arranged on a rear face side and a driver unit 6 arranged on a surface side are opposed to each other by interposing the stack tray 3. The sheet folding mechanism 2 comprising a pair of pinch rollers 7 and a push blade 8 are arranged on a lower side of the electric stapler 1, and a push blade 8 disposed on the rear face side is opposed to a tangential line of the pair of pinch rollers 7 disposed on the surface side. A position of the lifting type sheet aligning stopper 4 in an up and down direction is controlled by a control portion of the binding processing apparatus in accordance with a size of sheet, and when sheet is dropped from the copier to the stack tray 3 to impinge on the sheet aligning stopper 4 to stop, a middle point of sheet in a front and rear direction coincides with a position of a driver of the electric stapler 1. When one set of sheets are fed to the stack tray 3, the electric stapler 1 is started to strike staples to a plurality of portions of the sheets at the middle point in the front and rear direction to bind and thereafter, the sheet aligning stopper 4 is driven to move down to lower the position of the sheet. An amount of moving down the sheet aligning stopper 4 is controlled to be equal to an amount of displacing the driver and a clincher of the electric stapler 1 and the push blade 8 of the sheet folding mechanism 2 by the control portion, and when the sheet aligning stopper 4 is stopped, a front end of the push blade 8 is opposed to a position of striking the staple (center line of sheet). Further, the push blade 8 is driven in a direction of the sheet by a cam mechanism to press a portion of sheet to be bound to between a pair of pinch rollers 7, the pinch rollers 7 are driven to rotate to pull sheet while folding sheet to discharge on an opposed side. In this way, a copied document or the like is center-bound and folded in two to be finished as a center-bound document.

Although the above-described is the constitution of the conventional binding processing apparatus, according to the binding processing apparatus, when the sheets aligning stopper 4 are moved down after the staple processing, there is a case in which the sheets are warped or inclined by friction between the sheets and the stack tray 3 or the like, and when such a situation is brought about, a position of striking the stapler to the sheet and a position of the push blade do not coincide with each other, and the binding position and the position of a fold line are shifted from each other.

Hence, in order to resolve the above-described drawback, as shown by FIG. 6, there is proposed a constitution in which staple processing and sheet folding are carried out without carrying out positioning for sheet folding after staple processing by arranging the electric stapler and the sheet folding mechanism 2 at the same position. However, in this case, in order to avoid the driver unit 6 of the electric stapler 1 and the pinch roller 7 from interfering with each other, as shown by FIG. 7, it is necessary to divide the pinch roller 7, and also the pusher blade 8 needs to notch a portion thereof brought into contact with the clincher unit (not illustrated) to prevent the pusher blade 8 from being interfered with the clincher unit. Therefore, the center line of sheets is segmentally pressed by the divided pinch rollers, there is brought about a portion of sheet which is not pressed over a length in correspondence with a width of the driver unit 6 and the clincher unit to pose a problem that sheet folding becomes incomplete. Further, sheets are traveled to the pinch roller 7 after staple processing and therefore, there also poses a problem that sheet clogging is brought about in the step. Hence, there poses a technical problem to be resolved for improving finish and preventing sheet clogging in a binding processing apparatus having a constitution in which staple processing and sheet folding are carried out at the same position, and it is an object of the invention to resolve the above-described problem.

### DISCLOSURE OF THE INVENTION

The invention has been proposed to achieve the above-described object and there is provided an electric stapler including a driver unit having a driver and driver lifting means, and a clincher opposed to the driver, in which sheets are pinched by the driver unit and the clincher, a staple is injected by driving the driver, and a leg portion of the staple is folded to bend to bind the sheets by the clincher, constituted such that recess grooves are formed at two contiguous portions of a staple injecting port disposed at a bottom face of the driver unit, a side of the clincher is provided with the press blade pairing with the recess grooves to be fitted with each other and the press blade lifting means, and the sheets are pressed by the press blade and the recess groove by driving the press blade after operating to bind the sheet to form a fold line.

Further, there is provided the electric stapler provided with press blade control means for forming the fold line by pressing the sheet by the press blade and the recess groove by clamping the sheet by the press blade and the driver unit by driving the press blade before staring to operate to bind the sheets and further driving the press blade after operating to bind the sheets.

Further, there is provided the electric stapler provided with switching means for switching on and off to operate the press blade lifting means.

### BRIEF DESCRIPTION OF THE DRAWINGS

FIG. 1 shows one embodiment of the invention and is a side view of an electric stapler.

FIG. 2(a), FIG. 2(b) and FIG. 2(c) are front views showing a procedure of operating the electric stapler of FIG. 1.

FIG. 3(a) and FIG. 3(b) show an electric stapler, FIG. 3(a) is a side view in standby, and FIG. 3(b) is a side view in binding.

FIG. 4(a), FIG. 4(b) and FIG. 4(c) are front views showing a procedure of operating the electric stapler of FIG. 3.

FIG. 5 shows a conventional art and is a side sectional view of a biding processing apparatus.

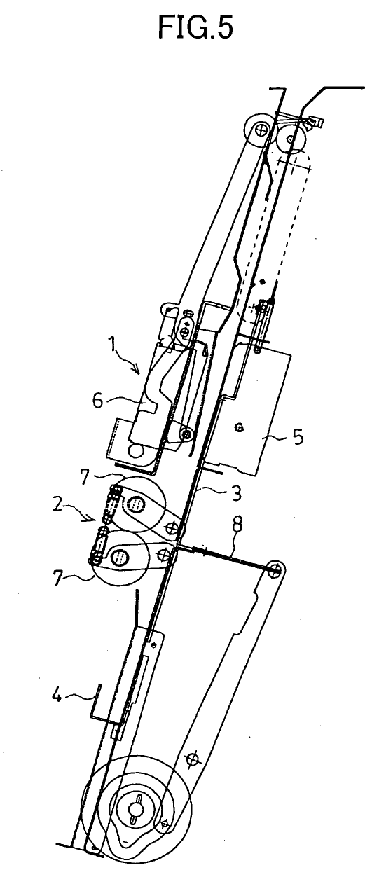

FIG. 6 shows other embodiment and is a side sectional view showing other mode of a binding processing apparatus.

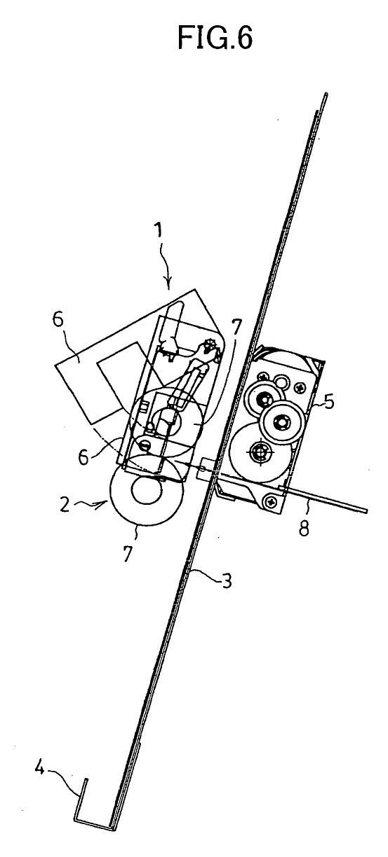

FIG. 7 is an explanatory view showing an arrangement of a mechanism of the binding processing apparatus of FIG. 6.

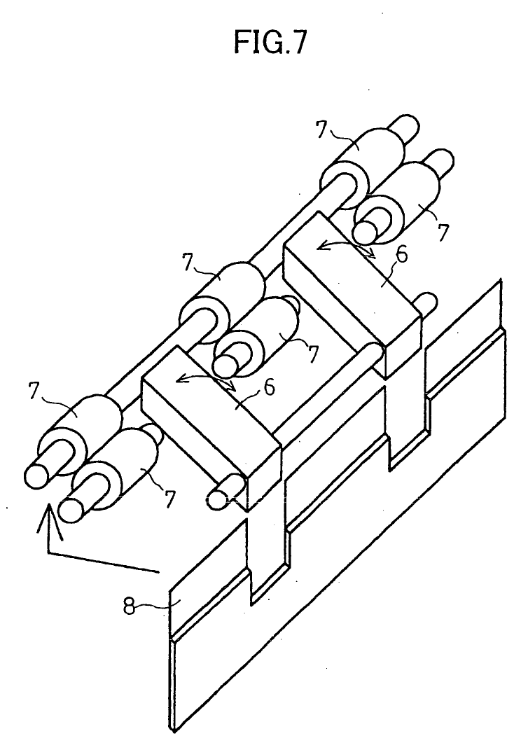

Further, in notations of the drawings, numeral 11 designates an electric stapler, numeral 12 designates a driver unit, numeral 13 designates a clincher unit, numeral 16 designates a clincher driving cam, numeral 17 designates a clincher, numeral 19 designates a press blade, numeral 20 designates a blade driving cam, numeral 21 designates a recess groove, numeral 31 designates an electric stapler, numeral 32 designates a driver unit, numeral 35 designates a clincher, numeral 36 designates a press blade, numeral 37 designates a blade driving cam, and numeral 38 designates a recess groove.

### BEST MODE FOR CARRYING OUT THE INVENTION

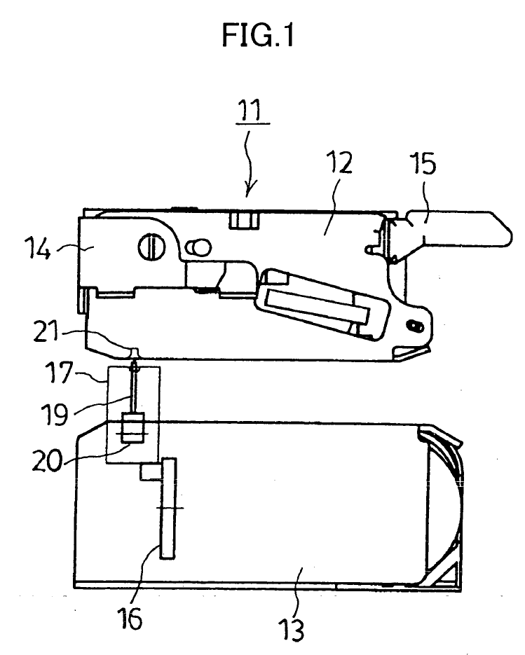

A detailed description will be given of a mode for carrying out the invention in reference to the drawings as follows. FIG. 1 shows the electric stapler 11, numeral 12 on an upper side designates the driver unit and numeral 13 on a lower side designates the clincher unit. A driver link 14 provided at the driver unit 12 is moved up and down to inject a staple at inside of a staple magazine 15 to a lower side by a driver (not illustrated) in a shape of a thin plate attached to a front end portion of the driver link 14. The clincher unit 13 drives the clincher 17 to reciprocate in an up and down direction by the clincher drive cam 16, and by moving up the staple magazine 15 by pressing sheet (not illustrated) to a bottom face of the driver unit 12 by moving up the clincher 17, the driver link 14 and the driver at the front end are moved down relative to the staple magazine 15. A leg portion of the staple injected by the driver impinges on a recess groove 18 at a center of the clincher 17 to be folded to bend.

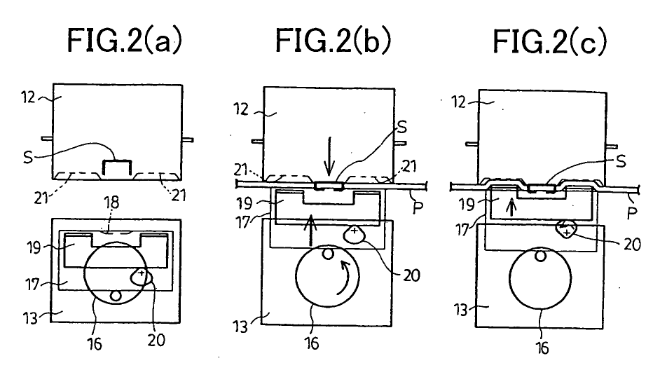

The press blade 19 is contained at inside of the clincher 17, and the press blade 19 is driven to reciprocate in the up and down direction by the blade driving cam 20 at inside of the clincher 17. As shown by FIG. 2, a center portion of an upper end of the press blade 19 is notched so as not to be interfered with the driver and the staple S, and left and right upper end portions thereof can be projected to an upper side through a groove (not illustrated) formed at the upper face of the clincher 17. The recess grooves 21 in correspondence with the press blade 19 at inside of the clincher unit 13 are formed on left and right sides of a staple injecting port disposed at a center of a bottom face of the driver unit 12, and when the press blade 19 is moved up, the left and right upper end portions of the press blade 19 are fitted to the recess grooves 21.

Next, operation of the electric stapler 11 will be explained. FIG. 2(a) shows an initial state in which the clincher 17 at inside of the clincher unit 13 is disposed at a lower standby position, and also the press blade 19 at inside of the clincher 17 is disposed at a lower standby position. Further, as shown by FIG. 2(b), when one set of sheets P is supplied to between the driver unit 12 and the clincher unit 13, the clincher drive cam 16 starts rotating to move up the clincher 17 to pinch the sheet by the clincher 17 and the bottom face of the driver unit 12. Simultaneously therewith, the driver at inside of the driver unit 12 is driven to move down to inject the staple S to the lower side to bind the sheets. Successively, as shown by FIG. 2(c), the blade driving cam 20 starts rotating to move up the press blade 19. The press blade 19 pushes the sheet P to the recess grooves 21 at the bottom face of the driver unit 12 to thereby attach folds at two left and right contiguous portions of the stapling portion. Further, after binding and pressing, the clincher driving cam 16 and the blade driving cam 20 finish to rotate by one rotation and the clincher 17 and the press blade 19 return to an initial state of FIG. 2(a).

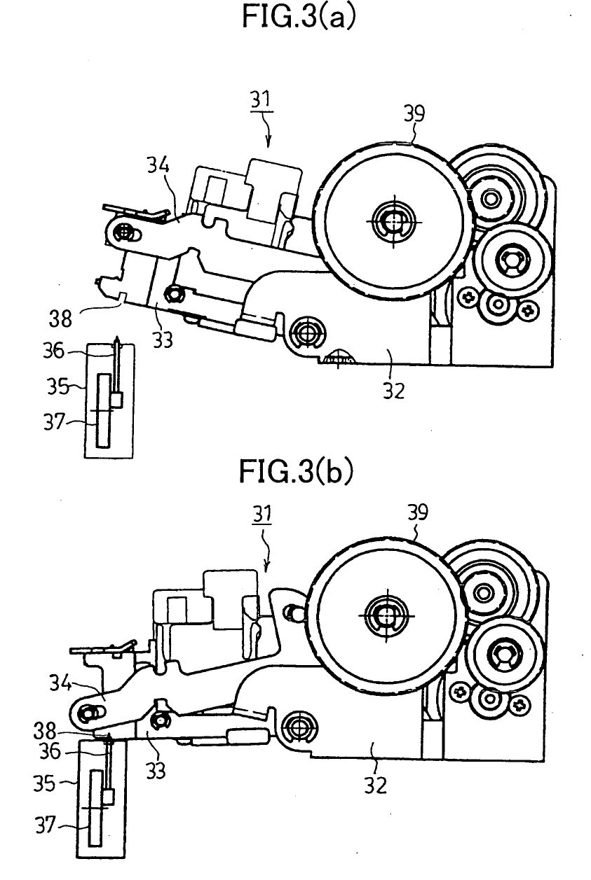

FIG. 3(a) and FIG. 3(b) show the electric stapler 31 of a clincher fixed type as other embodiment, and there is constructed a constitution in which a staple magazine holder portion 33 of the driver unit 32 and a driver link 34 and a driver (not illustrated) are driven to move up and down. The press blade 36 and the blade driving cam 37 are included at inside of the fixed type clincher 35 similar to the above embodiment, and when the blade driving cam 37 is rotated by one rotation from the initial position, the press blade 36 is reciprocated to move up and down from the lower standby position by one reciprocation. Further, the recess grooves 38 in correspondence with the press blade 36 are formed on left and right sides of a staple injecting port formed at a bottom face of the staple magazine holder 33 and when the press blade 36 is moved up, left and right upper end portions of the press blade 36 are fitted to the recess grooves 38 similar to the electric stapler 11 shown in FIG. 1 through FIG. 2(c).

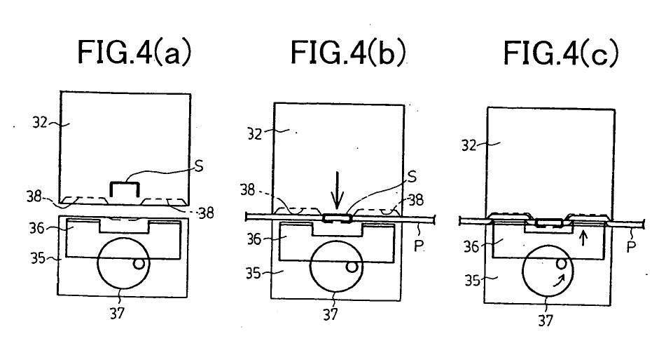

FIG. 4(a) through FIG. 4(c) show operation of the electric stapler 31, and in an initial state of FIG. 4(a), the press blade 36 at inside of the clincher 35 is disposed at the lower standby position. As shown by FIG. 4(b), when one set of sheets P is supplied to between the driver unit 32 and the clincher 35, a driver driving cam 39 starts to rotate to integrally move down the staple magazine holder portion 33 and the driver link 34 to pinch the sheets by the bottom face of the staple magazine holder portion 33 and the clincher 35. Further, as shown by FIG. 3(b) and FIG. 4(b), the driver link 34 is further moved down, and the driver injects the staple S to the lower side to bind the sheets. Successively, the blade driving cam 37 starts rotating, as shown by FIG. 4(c), the press blade 36 is moved up, and the press blade 36 presses the sheet to the recess grooves 38 at the bottom face of the staple magazine holder portion 33 to attach the folds at two left and right contiguous portions of the stapling portion of sheet. Further, after binding and pressing, a driver driving cam 39 and the blade driving cam 37 finish to rotate by one rotation to return the staple magazine holder portion 33 and the driver link 34 and the driver to the upper standby position, and the press blade 36 is moved down to return to the initial state of FIG. 4(a).

Further, although in the above-described embodiments, an explanation has been given of the constitution of starting to move the press blade after stapling, in place thereof, there may be constituted a cam mechanism such that sheet is clamped by the driver unit and the press blade by driving to move up the press blade before binding operation and the press blade is further driven to move up after stapling to press, thereby, sheets in stapling is further firmly fixed to prevent positional shift of sheets. Further, useless pressing may not be carried out in processing to bind an end portion of sheets by providing controlling means or a change over switch for stopping to operate the blade driving cam.

Further, the invention is not limited to the above-described embodiments but can variously be modified within a technical range of the invention and the invention naturally includes the modifications.

### INDUSTRIAL APPLICABILITY

According to the invention, a fold line by the press blade are formed to be proximate to both sides of a portion of sheet for striking the staple and therefore, the electric stapler for carrying out excellent finish is provided. Further, staple processing and sheet folding processing are carried out without being accompanied by traveling of sheet at all and therefore, the electric stapler having high stability without bringing about sheet clogging is provided.

1. An electric stapler comprising:
a driver unit including a driver and driver lifting means;
a clincher opposed to the driver, wherein sheets of paper are pinched by the driver unit and the clincher, a staple is injected by driving the driver and the sheets are bound by folding to bend leg portions of the staple by the clincher;
recess grooves formed at two contiguous portions of a staple injecting port of the driver unit;
a press blade provided on a side of the clincher, wherein the press blade and the recess grooves are fittable to each other; and
a press blade lifting means,
wherein a fold line is formed by pressing the sheets by the press blade and the recess grooves by driving the press blade after operating to bind the sheet.

2. The electric stapler according to claim 1, wherein the sheet is clamped by the press blade and the driver unit by driving the press blade before starting to operate to bind the sheet and the press blade is further driven after operating to bind the sheet to form the fold line by pressing the sheet by the press blade and the recess groove.

3. The electric stapler according to claim 1, further comprising switching means for switching ON and OFF an operation of the press blade lifting means.

4. An electric stapler comprising:
a driver unit including a driver and a staple injecting port;
a clincher opposed to the driver, wherein sheets of paper are pinched by the driver unit and the clincher, a staple is injected by the driver and the sheets are bound by folding to bend leg portions of the staple by the clincher;
recess grooves formed on the driver unit at two contiguous portions of the staple injecting port; and
a press blade provided on the clincher, wherein the press blade is liftable to fit with the recess grooves,
wherein a fold line is formed on the sheets by pressing the sheets by the press blade and the recess grooves by lifting the press blade.

5. The electric stapler according to claim 4, wherein the press blade is lifted to pinch the sheets when the staple is injected, and
wherein the press blade is further lifted when the fold line is formed on the sheets.

6. A method for binding sheets of paper and forming a fold line on the sheets comprising:
pinching sheets of paper by a driver unit and a clincher;
injecting a staple by the driver from a staple injecting port on the driver unit;
bending leg portions of the staple by the clincher;
lifting a press blade provided on the clincher to fit with recess grooves formed on the driver unit at two contiguous portions of the staple injecting port;
forming a fold line on the sheets.

7. The method according to claim 6, wherein, in the pinching step, the sheets are clamped by the press blade and the driver unit.
